(19) United States
(12) Patent Application Publication
(10) Pub. No.: US 2014/0172677 A1
(43) Pub. Date: Jun. 19, 2014

(54) PROVIDING COMBINED ACCESS TO BUSINESS AND PERSONAL CREDIT INFORMATION

(71) Applicant: CREDITERA, LLC, South Jordan, UT (US)

(72) Inventors: David Levi King, South Jordan, UT (US); David Lavon King, Sandy, UT (US); Caton Vance Hanson, South Jordan, UT (US)

(73) Assignee: Creditera, LLC, South Jordan, UT (US)

(21) Appl. No.: 13/713,743

(22) Filed: Dec. 13, 2012

(51) Int. Cl. G06Q 40/02

(52) U.S. Cl. CPC G06Q 40/025
USPC 705/38

(57) ABSTRACT

The present invention is directed to the combining of personal credit information for an individual and business credit information of a business with which the individual is associated. For example, the invention can provide a website where a user can request to view an individual's personal credit information and the business credit information of a business that the individual owns. In this manner, the user can quickly and easily obtain a more complete view of the financial status of an individual or a business in a single location.

### FIELD

This disclosure relates generally to credit reports. More specifically, this disclosure relates to providing business and personal credit information in a single access point.

### BACKGROUND

The financial health of a business is often linked to the financial health of the individual or individuals that own or manage the business. This is particularly true with small businesses where there is a high degree of correlation between the owner's personal financial health and the financial health of the business.

Credit rating agencies such as Experian, Equifax, and others collect data regarding the financial health of individuals and businesses. The financial health is sometimes represented as a credit score for the individual or the business.

Although credit scores exist for businesses and individuals, there is no convenient or simple way to quickly access both an individual's personal credit score and the credit score of any businesses the individual owns or is closely involved with. For example, a lender or other business that desires to transact with an individual can run a credit report on the individual to determine the risk of transacting with the individual. The lender can also discover any businesses the individual owns and run separate credit reports on each business.

In this example, using current approaches for obtaining a credit score, the lender would have to make separate inquiries for the individual and each of the businesses associated with the individual. For example, Experian provides separate websites for obtaining a personal credit score and a business credit score.

The same is true if an individual desires to monitor his or her personal credit score and the credit score of any businesses he or she owns or is associated with. Accordingly, because personal and business credit scores are maintained and accessed as separate information, compiling a complete view of the financial health and risk profile of an individual or business can be a difficult, expensive, and time-consuming process.

### BRIEF SUMMARY

Methods, systems, and computer program products for providing access to a combined presentation of business and personal credit information are disclosed. Embodiments can be embodied as a website, mobile application, or other interface for providing a single access point to access an individual's personal credit information and business credit information of any businesses with which the individual is associated. The credit information may be provided as a combined presentation allowing access to both individual and business credit information from a single displayed page or site, or may provide both types of credit information in a single displayed page or site.

In one embodiment, a method for generating a combined presentation of personal credit information and business credit information may include a request from a client computing device requesting personal credit information of a first individual and business credit information of a first business with which the first individual is associated. The personal credit information of the first individual and the business credit information of the first business may then be accessed. A combined presentation of the personal credit information and the business credit information may be generated. The combined presentation of access to the personal credit information and the business credit information may then be sent to the client computing device for display on the client computing device.

In another embodiment for generating a combined presentation of personal credit information and business credit information may include receiving a request from a client computing device that identifies a first individual and requests personal credit information of the first individual and business credit information of any businesses with which the first individual is associated. A determination that the first individual is associated with a first business may be performed. The personal credit information of the first individual and the business credit information of the first business may then accessed. A combined presentation of the personal credit information and the business credit information may be generated. The combined presentation of the personal credit information and the business credit information may be sent to the client computing device for display on the client computing device.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be provided by reference to specific embodiments which are illustrated in the appended drawings. The drawings depict only typical embodiments of the invention and are not, therefore, to be considered to be limiting of its scope. The invention will be described and explained with additional specificity and detail through the use of the accompanying drawings in which:

FIG. 1 illustrates an exemplary computing environment in which exemplary systems and methods of providing access to both personal and business credit information from a single point of access can be implemented;

FIGS. 2A-2B illustrate communications that can occur between computing devices to receive a combined presentation of a personal credit score and a business credit score;

FIGS. 3A-3D and 4A-4B illustrate exemplary combined credit reports according to one or more embodiments; and

FIGS. 5-7 each illustrate a flowchart of an exemplary method for generating a combined presentation of personal credit information and business credit information.

### DETAILED DESCRIPTION

Methods, systems, and computer program products for providing access to a combined presentation of business and personal credit information are disclosed. Embodiments can be embodied as a website, mobile application, or other interface for providing a single access point to access an individual's personal credit information and business credit information of any businesses with which the individual is associated. The credit information may be provided as a combined presentation allowing access to both individual and business credit information from a single displayed page or site, or may provide both types of credit information in a single displayed page or site.

In one embodiment, a method for generating a combined presentation of personal credit information and business credit information may include a request from a client computing device requesting personal credit information of a first individual and business credit information of a first business with which the first individual is associated. The personal credit information of the first individual and the business credit information of the first business may then be accessed. A combined presentation of the personal credit information and the business credit information may be generated. The combined presentation of access to the personal credit information and the business credit information may then be sent to the client computing device for display on the client computing device.

In another embodiment for generating a combined presentation of personal credit information and business credit information may include receiving a request from a client computing device that identifies a first individual and requests personal credit information of the first individual and business credit information of any businesses with which the first individual is associated. A determination that the first individual is associated with a first business may be performed. The personal credit information of the first individual and the business credit information of the first business may then accessed. A combined presentation of the personal credit information and the business credit information may be generated. The combined presentation of the personal credit information and the business credit information may be sent to the client computing device for display on the client computing device.

Exemplary methods, systems, and computer program products for providing access to business and personal credit information may include or utilize special purpose or general-purpose computers including computer hardware, such as, for example, one or more processors and system memory, as discussed in greater detail below. Embodiments may also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the disclosed embodiments may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

Methods, systems, and programs for providing access to business and personal credit information may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

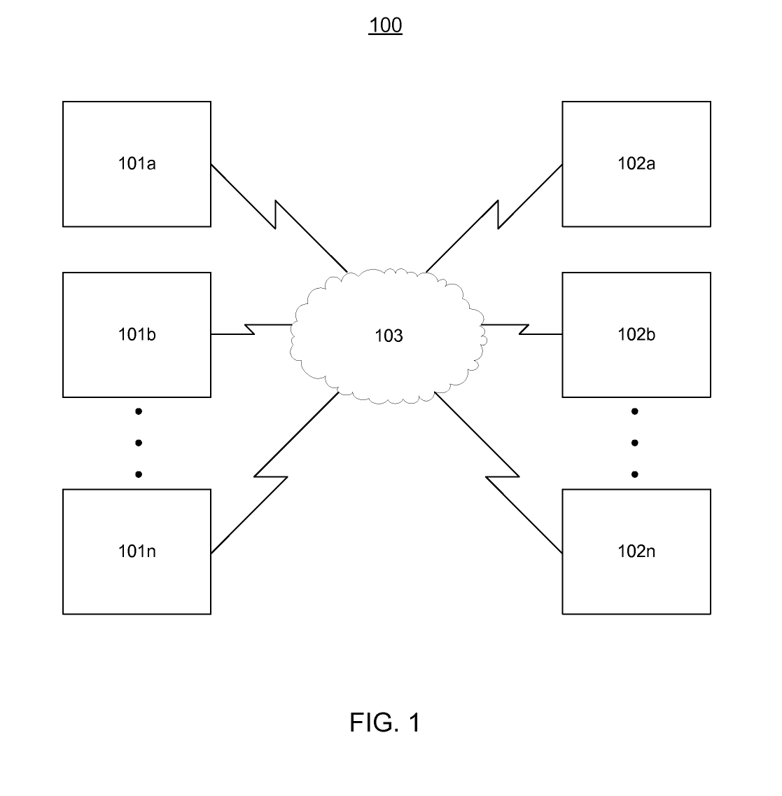

FIG. 1 illustrates an exemplary computer environment 100 in which embodiments of methods, systems, and programs for providing access to business and personal credit information can be implemented. Computer environment 100 may include server systems 101a-101n and client computer systems 102a-102n. Server systems 101a-101n may include any type of computer system that is accessible over a network. In a typical environment, server systems 101a-101n may include servers or clouds of server computing devices that are used by one or more businesses to supply information or services to clients.

Client computer systems 102a-102n may include any type of computing device that can connect to one or more of server computer systems 101a-101n via network 103. For example, client computer systems 102a-102n may include a mobile phone, a tablet, a laptop, a desktop computer, etc. that connects to server computer systems 101a-101n via the internet.

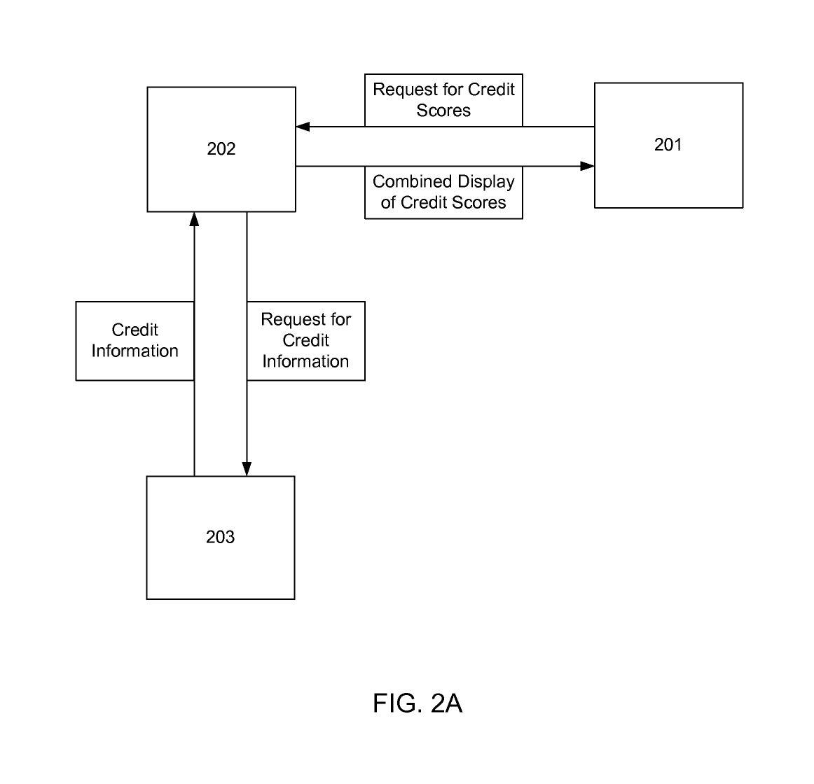

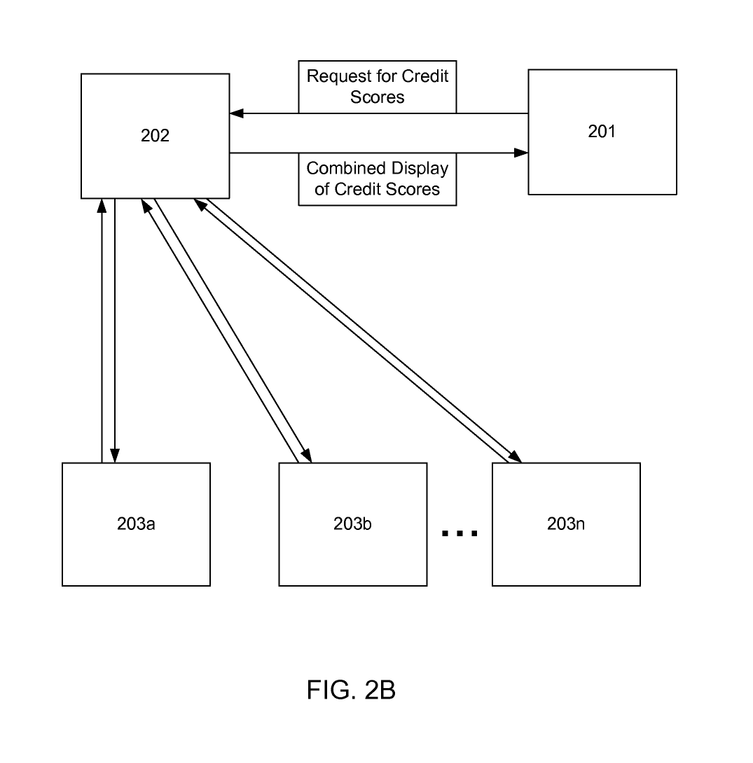

FIG. 2A illustrates an exemplary configuration of computer environment 100 in which a client computing device 201 may access a server system 202 to view a combined presentation of an individual's personal credit information and credit information of one or more businesses with which the individual is associated. In the remainder of the specification, credit scores are frequently used as specific examples of a type of credit information. However, credit information may include information other than a credit score of an individual or a business, such as credit-related information typically used to generate a credit score or rating.

As shown, server system 202 may receive credit information from server system 203. In this example, server system 202 can represent a server maintained by a first entity for providing a website where credit information can be obtained, and server system 203 can include a server system maintained by a credit bureau such as Experian, Transunion, Equifax, Dun and Bradstreet, etc.

Although FIG. 2A shows that credit information may be obtained from a single server system 203. In some embodiments, server system 202 can also obtain credit information from multiple different server systems. For example, server system 202 can obtain credit information from a server system maintained by Experian and a server system maintained by Transunion.

Server system 202 can be configured to obtain credit information regarding individuals and businesses both before a request for the information is received and in response to receiving a request for the information. For example, server system 202 can be configured to continuously compile credit information into a database so that server system 202 can respond to requests by accessing its own database. On the other hand, server system 202 can be configured to first receive a request for credit information before obtaining the requested information from server system 203. In other words, the specific manner in which server system 202 obtains credit information is flexible. In particular, embodiments of methods, systems, and programs for providing access to business and personal credit information could be implemented directly by a company that maintains credit scores for businesses or individuals and therefore may not need to access another server system to obtain a credit score for an individual or business.

Client computing device 201 can make requests to server system 202 over network 203 which is generally the internet, but can be any other network that interconnects the systems. These requests can be requests to view or download credit information relevant to a particular individual or business.

For example, client computing device 201 can submit a request to view credit information regarding a small business. In response to the request, server system 202 can access credit information and determine a business credit score for the small business. Additionally, server system 202 can determine that the small business is owned by a first individual, and can access credit information and determine the personal credit score for the first individual. As stated above, these two scores can be obtained by querying server system 203 or by accessing stored credit scores that had already been received by server system 202. Alternatively, these scores can be generated and maintained locally by server system 202 in which case, server system 202 need not access server system 203 to obtain the credit information.

Server system 202 can then generate a combined presentation of the small business's credit score and the first individual's credit score. This combined presentation can be returned to client computing device 201 for display on client computing device 201 such as in the form of a webpage, associated webpages, or application content. In this way, the user of client computing device 201, with a single request to server system 202, can receive a more complete view of the financial health and credit worthiness of the small business.

In another example, client computing device 201 can submit a request to view credit information regarding a second individual. Similar to the example above, server system 202 can access credit information and determine the personal credit score of the second individual, and can also determine if the second individual owns or is otherwise associated with a business. If the second individual owns any businesses, server system 202 can obtain the business credit information of each business and can generate a combined presentation of the second individual's personal credit information and the business' credit information of any associated businesses.

FIG. 2B illustrates an implementation when server system 202 accesses three or more other server systems 203a-203n to obtain credit information for generating a combined presentation of credit scores. For example, server systems 203a-203n can represent three or more separate credit bureaus, including personal credit and business credit bureaus.

In this example, server system 202 can request a personal credit score and a business credit score from each of server systems 203a-203n. Alternatively, server system 202 can request only a personal credit score from one of server systems 203a-203n and only a business credit score from another of server systems 203a-203n. In any case, in this example, server system 202 can receive many different credit scores (e.g., various separate personal credit scores and various separate business credit scores). The combined presentation of the credit information returned to client computing device 201 can include any or all of these credit scores obtained by server system 202. Of course, this example applies equally to scenarios where a different number of servers 203 are accessed to retrieve credit information.

Server system 202 can use various criteria to determine which individuals are associated with a business in such a way that the individual's credit score would be relevant to the business's credit score and vice versa. In the most basic example, the credit score of an owner of the business can be deemed relevant to the credit score of the business and vice versa. In a more complex example, server system 202 can use criteria such as percent of ownership, management role, etc. to determine whether an individual's credit score is likely to affect or be affected by the credit score of the associated business.

In other embodiments, server system 202 can allow client computing device 201 to specify an individual and any associated businesses in the request. For example, the user of client computing device 201 may already know that an individual is an owner of a business, and can request credit information for the individual and the business using a single request to server system 202. In such cases, server system 202 can use criteria to determine whether to include or suggest including the credit information of any other businesses an individual may be associated with. Similarly, server system 202 can use criteria to determine whether to include or suggest including the credit information of any other individual associated with a specified business.

In addition to allowing a user to make requests for combined personal and business credit information, embodiments of methods, systems, and programs for providing access to business and personal credit information can also allow a user to receive alerts regarding any of the linked credit reports. For example, client computing device 201 can register with server system 202 to receive an alert when there is a change in the credit score of a business or in the credit score of any associated individual. In this way, the user can be automatically notified of a change to any of the associated credit scores or other relevant credit information.

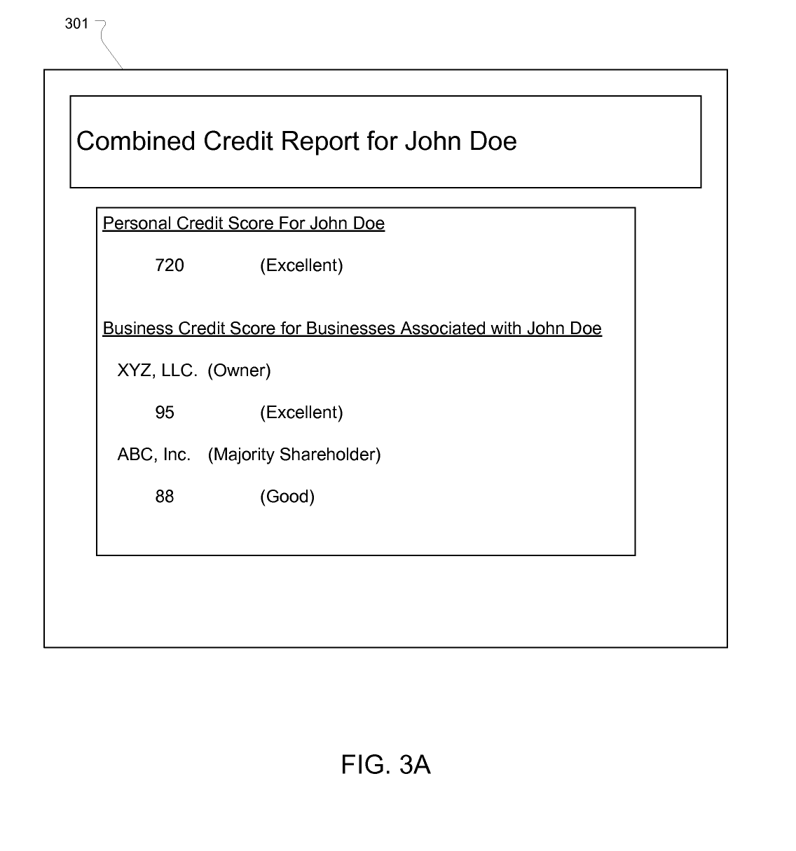

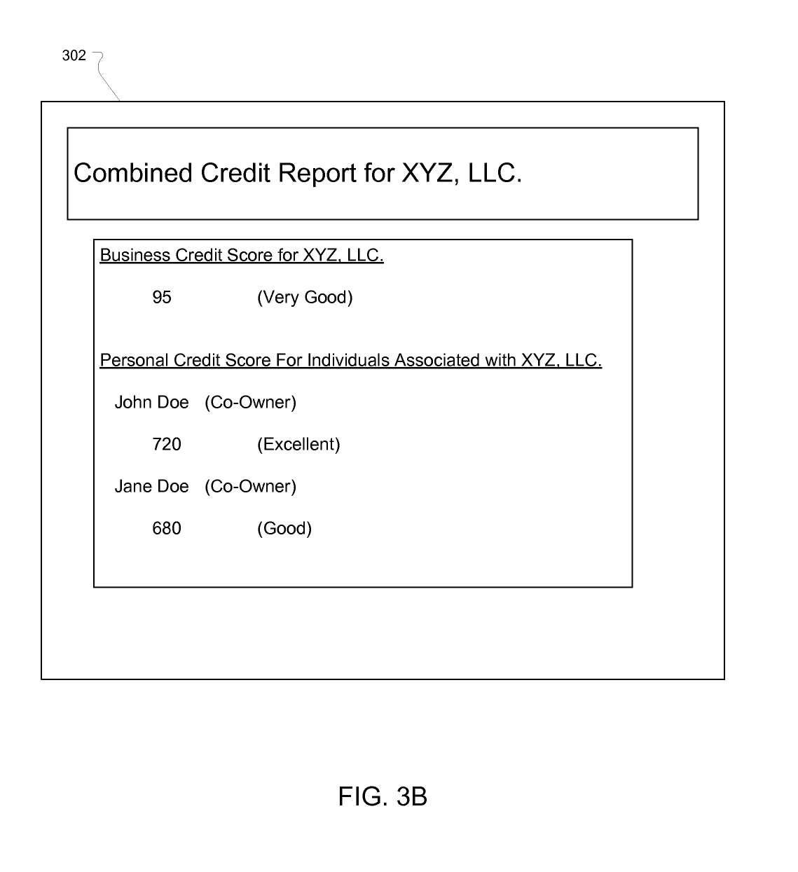

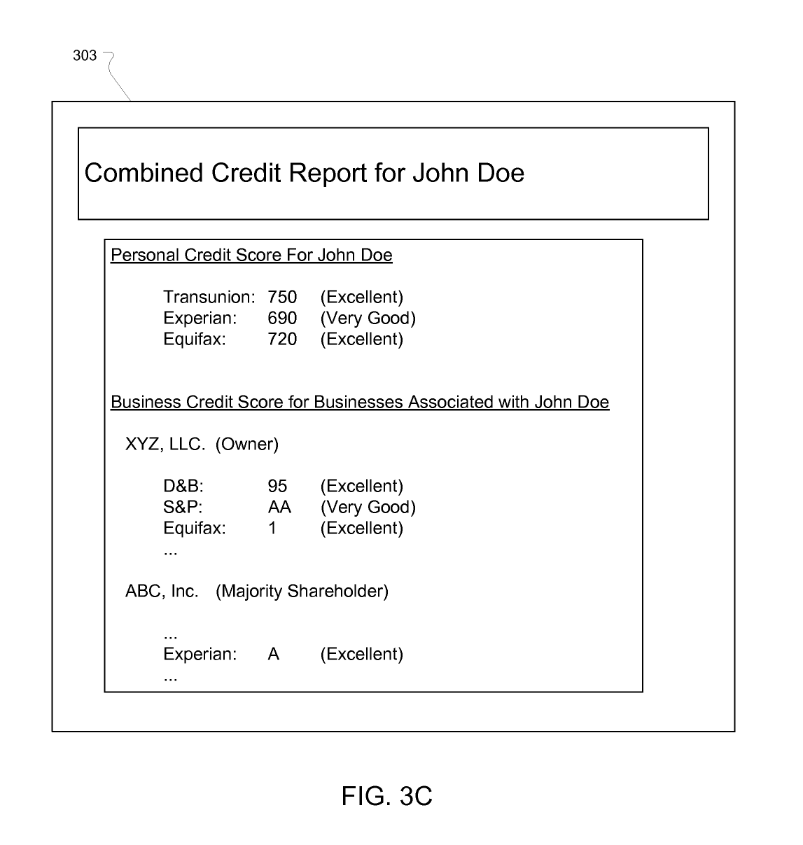

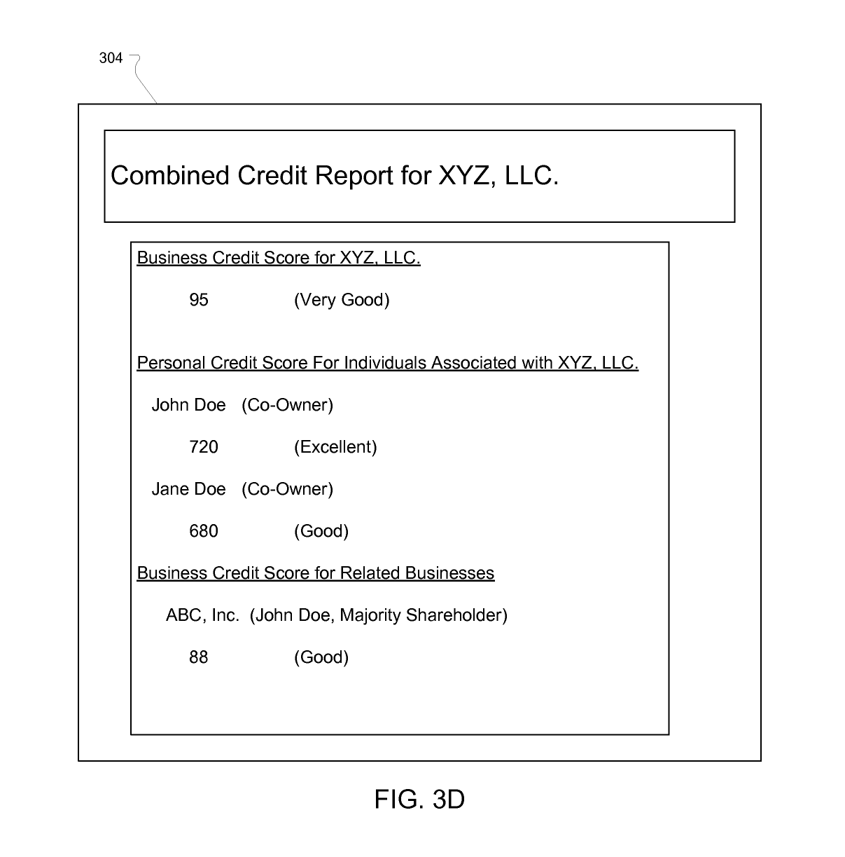

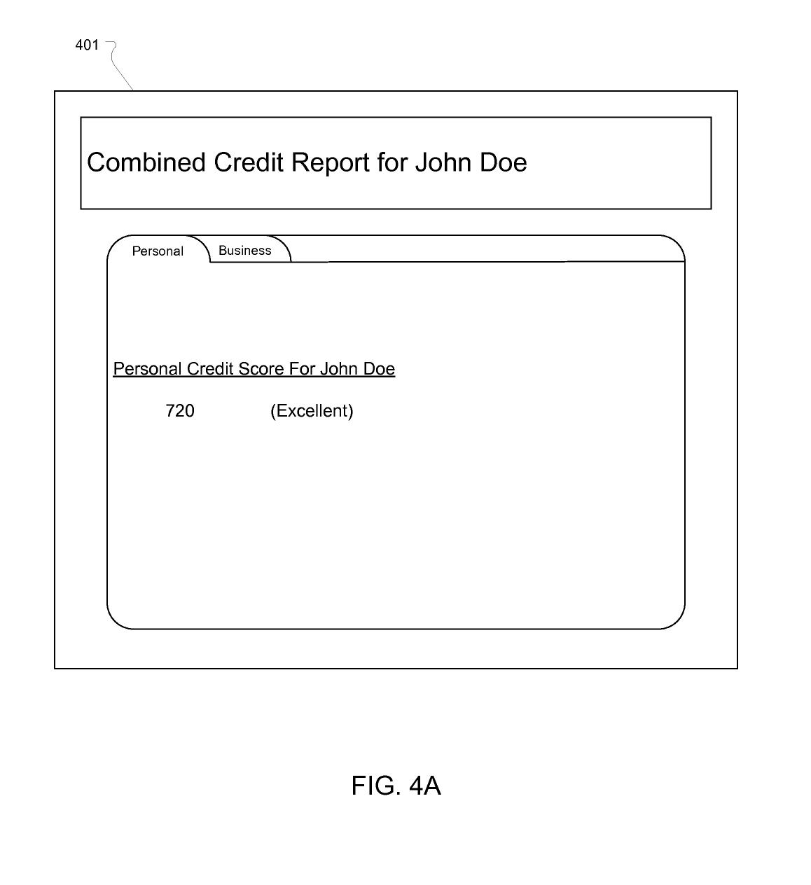

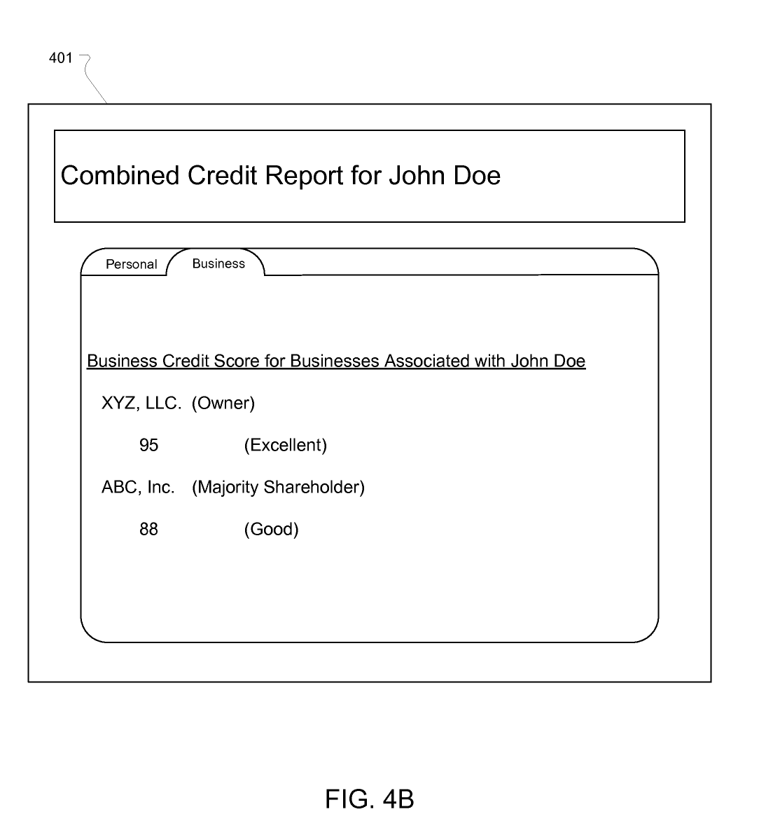

FIGS. 3 and 4 illustrate various exemplary combined presentations of personal and business credit information. In some embodiments, a combined presentation may include a display that is accessible using a single user account or login. For example, if the combined presentation is provided in a website, a user can access the combined presentation using a single set of login credentials (e.g. username and password). In this manner, the combined presentation can be more easily and quickly accessed. FIG. 3 illustrates various examples where the combined presentation may include a single screen that includes both personal and business credit information. On the other hand, FIG. 4 illustrates various examples where the combined presentation may include different screens for the personal and business credit information which are each accessible from a common account or login.

FIG. 3A illustrates an exemplary combined credit report 301 for an individual, John Doe. Report 301 can be generated in response to a request to view John Doe's personal credit score and the business credit score of any businesses with which John Doe is associated.

Report 301 may include a personal credit score of 720 for John Doe. This personal credit score can be based on any combination of credit scores reported by the various credit agencies. For example, it can be a single score reported by one credit agency, or a combination of scores reported by the three major personal credit reporting agencies (average, mean, etc.), or may be the top, bottom, or middle score, as desired.

Report 301 may also include a business credit score for two businesses with which John Doe is associated. A first business, XYZ, LLC., which John Doe owns, has a business credit score of 95, while a second business, ABC, Inc., of which John Doe is a majority shareholder, has a business credit score of 88. Like the personal credit score, the business credit scores can be based on any number of the scores reported by the various business credit agencies.

FIG. 3B illustrates another exemplary combined credit report 302 for the business, XYZ, LLC. Report 302 can be generated in response to a request to view XYZ's business credit score and the personal credit score of individuals associated with XYZ, LLC. Report 302 may provide the business credit score of 95, and also provide the personal credit score of two owners of XYZ, LLC., John Doe (720) and Jane Doe (680).

FIG. 3C illustrates another exemplary combined credit report 303 which is a more detailed version of combined credit report 301. As shown, report 303 may include multiple credit scores for John Doe, XYZ, LLC., and ABC, Inc. Specifically, John Doe's personal credit scores with the three major credit agencies are listed. Similarly, each business's credit score with a number of business credit agencies may be listed.

Each business credit agency uses its own scale for reporting a business's credit score. In some embodiments, as shown in report 303, each of these scores can be listed. In other embodiments, a combined score can be generated to report a business's credit score. For example, embodiments of the present invention can define its own scale to provide a single credit score that is based on the combination of any number of the scores provided by business credit agencies.

Additionally, other credit information and full credit reports may be provided. Links may be provided to access, generate, or display a single credit report from each of the credit reporting agencies by clicking on the reported score or reporting agency listed under each entity. For example, if the “S&P” or “AA” is clicked under the XYX, LLC. listing, credit information provided by S&P on XYZ may be provided or displayed. Similarly, selected portions of the credit information may be presented based on pre-selected filters, such as for loan information only, or for credit inquiries, negatives, and other information in addition.

FIG. 3D illustrates another exemplary combined credit report 304 which is similar to report 302 with the addition of the business credit score of ABC, Inc. In some embodiments, the business credit scores of related businesses can also be provided when a user requests a business's credit score. In report 304, ABC, Inc.'s credit score is also reported because it is determined that ABC's credit score is likely relevant to XYZ's credit score because John Doe is associated with both businesses. In some embodiment, the level of detail provided in a report can be a user configurable option.

FIGS. 4A and 4B illustrate an exemplary combined credit report 401 that includes a tab for personal credit information and a tab for business credit information. Combined credit report 401 is similar to combined credit report 301 shown in FIG. 3A. In some embodiments, a separate tab can be provided for each individual and business included in a combined credit report. Of course, other user interface designs can also be used such as by providing other types of links to each additional screen or report of a combined credit report.

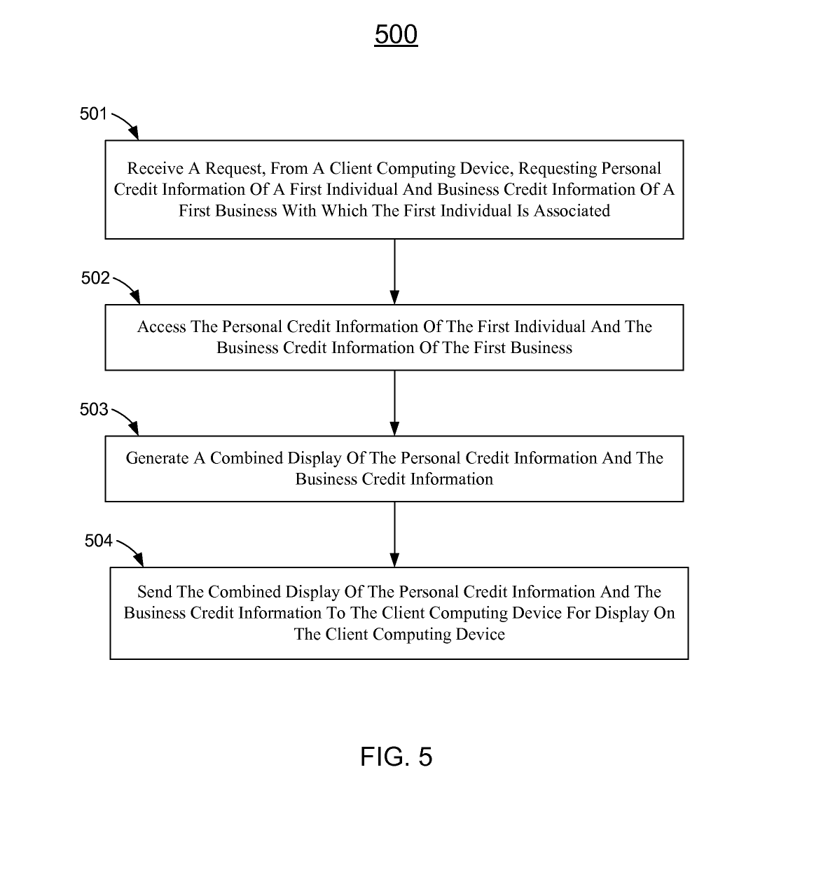

FIG. 5 illustrates a flowchart of an exemplary method 500 for generating a combined presentation of a personal credit score and a business credit score. Method 500 will be described with respect to the Figures.

Method 500 may include an act 501 of receiving a request, from a client computing device, requesting a personal credit score of a first individual and a business credit score of a first business with which the first individual is associated. For example, server system 202 can receive a request from client computing device 201 for the personal credit score of an individual and the business credit score of a business owned by the individual. Method 500 may also include an act 502 of accessing the personal credit information of the first individual and the business credit information of the first business. For example, server system 202 can access the personal and business credit information from one or more other server systems 203, or can access locally stored personal and business credit information.

Method 500 may include an act 503 of generating a combined presentation of the personal credit information and the business credit information. For example, server system 202 can generate a webpage that includes a report (e.g. any of reports 301-304 or 401) that includes a listing of personal and business credit information. Method 500 may further include an act 504 of sending the combined presentation of the personal credit information and the business credit information to the client computing device for display on the client computing device. For example, server system 202 can return the generated webpage to client computing device 201.

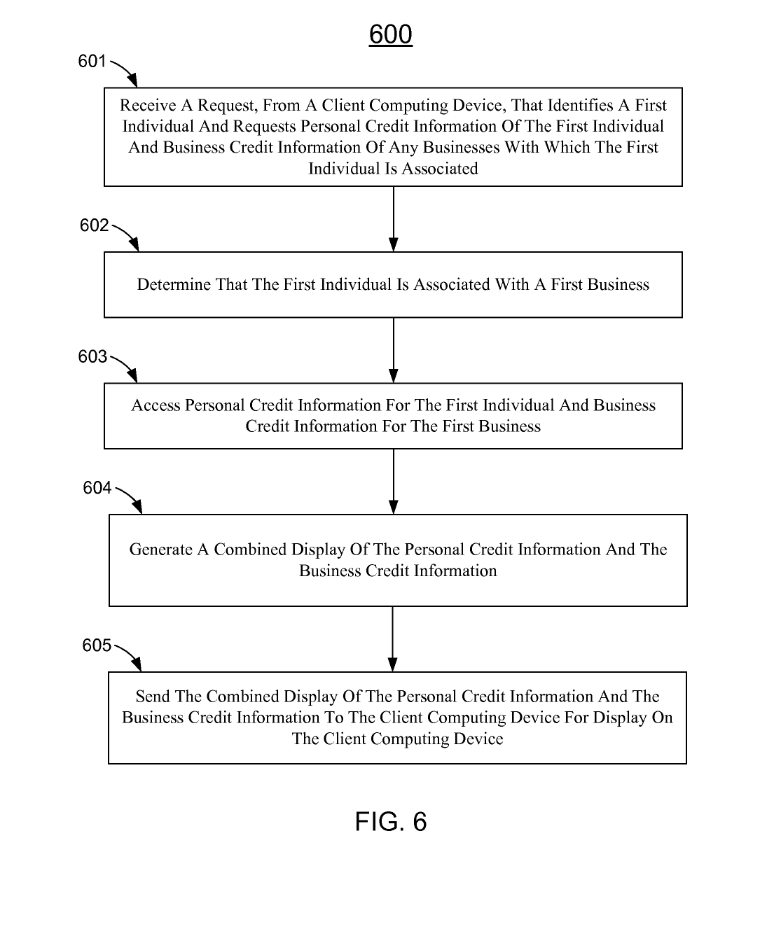

FIG. 6 illustrates a flowchart of an exemplary method 600 for generating a combined presentation of personal credit information and business credit information. Method 600 will be described with respect to the Figures.

Method 600 may include an act 601 of receiving a request, from a client computing device, that identifies a first individual and requests personal credit information of the first individual and business credit information of any businesses with which the first individual is associated. For example, server system 202 can receive a request from client computing device 201 for personal credit information of an individual and business credit information of any businesses with which the individual is associated. Method 600 may further include an act 602 of determining that the first individual is associated with a first business. For example, server system 202 can determine that the individual owns a business.

Method 600 may include an act 603 of accessing a personal credit information for the first individual and a business credit information for the first business. For example, server system 202 can access the personal and business credit information from one or more other server systems 203, or can access locally stored personal and business credit information. Method 600 may also include an act 604 of generating a combined presentation of the personal credit information and the business credit information. For example, server system 202 can generate a webpage that includes a report (e.g. any of reports 301-304 or 401) that includes a listing of the personal and business credit information.

Method 600 may also include an act 605 of sending the combined presentation of the personal credit information and the business credit information to the client computing device for display on the client computing device. For example, server system 202 can return the generated webpage to client computing device 201.

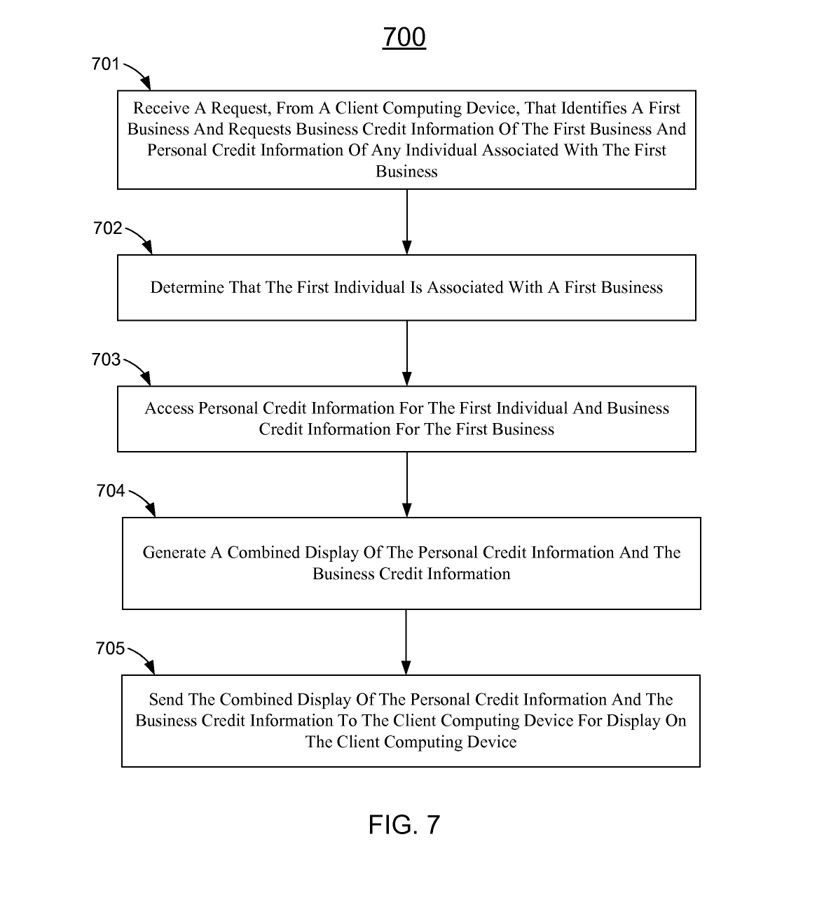

FIG. 7 illustrates a flowchart of an exemplary method 700 for generating a combined presentation of personal credit information and business credit information. Method 700 will be described with respect to the Figures.

Method 700 may include an act 701 of receiving a request, from a client computing device, that identifies a first business and requests a business credit information of the first business and a personal credit information of any individual associated with the first business. For example, server system 202 can receive a request from client computing device 201 for the business credit information of a business and the personal credit information of any individuals associated with the business.

Method 700 may also include an act 702 of determining that the first individual is associated with a first business. For example, server system 202 can determine that one or more individuals own the business. Method 700 may further include an act 703 of accessing a personal credit information for the first individual and a business credit information for the first business. For example, server system 202 can access the personal and business credit information from one or more other server systems 203, or can access a locally stored personal and business credit information.

Method 700 may include an act 704 of generating a combined presentation of the personal credit information and the business credit information. For example, server system 202 can generate a webpage that includes a report (e.g. any of reports 301-304 or 401) that includes a listing of the personal and business credit information. Method 700 may also include an act 705 of sending the combined presentation of the personal credit information and the business credit information to the client computing device for display on the client computing device. For example, server system 202 can return the generated webpage to client computing device 201.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation, and use may be made without departing from the principles and concepts set forth herein. Also, as used herein, the examples and embodiments, in all respects, are meant to be illustrative only and should not be construed to be limiting in any manner.

What is claimed:

1. A method, performed by a computer system, for generating a combined presentation of personal credit information and business credit information, the method comprising:
receiving a request, from a client computing device, requesting personal credit information of a first individual and business credit information of a first business with which the first individual is associated;
accessing the personal credit information of the first individual and the business credit information of the first business;
generating a combined presentation of the personal credit information and the business credit information; and
sending the combined presentation of the personal credit information and the business credit information to the client computing device for display on the client computing device.

2. The method of claim 1, wherein the request identifies the first individual but does not identify the first business, the method further comprising:
determining that the first individual is associated with the first business.

3. The method of claim 1, wherein determining that the first individual is associated with the first business comprises determining that the first individual is an owner of the first business.

4. The method of claim 1, wherein the request identifies the first business but does not identify the first individual, the method further comprising:
determining that the first individual is associated with the first business.

5. The method of claim 4, wherein determining that the first individual is associated with the first business comprises determining that the first individual is an owner of the first business.

6. The method of claim 1, wherein accessing the personal credit information of the first individual and the business credit information of the first business comprises requesting the personal credit information and the business credit information from one or more other computer systems.

7. The method of claim 6, wherein the one or more other computer systems comprise one or more credit bureaus.

8. The method of claim 1, wherein accessing the personal credit information of the first individual and the business credit information of the first business comprises accessing a locally stored personal credit information and business credit information.

9. The method of claim 1, wherein generating a combined presentation of the personal credit information and the business credit information comprises generating a web page that contains access to the personal credit information and the business credit information.

10. The method of claim 9, wherein generating a combined presentation of the personal credit information and the business credit information comprises generating content which when rendered by the client computing device causes the client computing device to generate a display that includes the personal credit information and the business credit information.

11. The method of claim 1, further comprising:
determining that a second individual is associated with the first business;
accessing the personal credit information of the second individual; and
including the personal credit information of the second individual in the generated combined presentation.

12. The method of claim 1, further comprising:
determining that the first individual is associated with a second business;
accessing the business credit information of the second business; and
including the business credit information of the second business in the generated combined presentation.

13. The method of claim 1, further comprising:
monitoring the personal credit information and the business credit information; and
determining that activity related to either the personal credit information or the business credit information has occurred; and
sending an alert to the client computing device or another client computing device associated with the client computing device, the alert identifying that the activity has occurred.

14. The method of claim 13, wherein the activity comprises a change in either the personal credit information of the business credit information.

15. The method of claim 13, further comprising:
receiving a request to modify the registration to receive alerts.

16. The method of claim 15, wherein the modification to the registration comprises a request to receive alerts regarding a credit information of another individual or business associated with the first individual or first business.

17. A method, performed by a computer system, for generating a combined presentation of personal credit information and business credit information, the method comprising:
receiving a request, from a client computing device, that identifies a first individual and requests personal credit information of the first individual and business credit information of any businesses with which the first individual is associated;
determining that the first individual is associated with a first business;
accessing personal credit information for the first individual and business credit information for the first business;
generating a combined presentation of the personal credit information and the business credit information; and
sending the combined presentation of the personal credit information and the business credit information to the client computing device for display on the client computing device.

18. The method of claim 17, wherein determining that the first individual is associated with a first business comprises determining that the first individual owns the first business.

19. The method of claim 17, further comprising:
determining that the first individual is associated with a second business;
accessing a business credit information of the second business; and
including the business credit information of the second business in the generated combined presentation.

20. The method of claim 17, further comprising:
determining that a second individual is associated with the first business;
accessing a personal credit information of the second individual; and
including the personal credit information of the second individual in the generated combined presentation.

21. The method of claim 20, wherein determining that a second individual is associated with the first business comprises determining that the second individual is an owner of the first business.

22. The method of claim 17, further comprising:
monitoring the personal credit information of the first individual and the business credit information of the first business;
determining that activity related to either the personal credit information or the business credit information has occurred; and
sending an alert to the client computing device or another client computing device associated with the client computing device, the alert identifying that the activity has occurred.

23. The method of claim 22, wherein the activity comprises a change in the personal credit information of the business credit information.

24. The method of claim 22, wherein the activity comprises a change in the ownership of the first business.

25. The method of claim 24, wherein the alert includes a personal credit information of a new owner of the first business.

26. A method, performed by a computer system, for generating a combined presentation of personal credit information and business credit information, the method comprising:
receiving a request, from a client computing device, that identifies a first business and requests business credit information of the first business and personal credit information of any individual associated with the first business;
determining that a first individual is associated with the first business;
accessing personal credit information for the first individual and business credit information for the first business;
generating a combined presentation of the personal credit information and the business credit information; and
sending the combined presentation of the personal credit information and the business credit information to the client computing device for display on the client computing device.

27. The method of claim 26, wherein determining that a first individual is associated with the first business comprises determining that the first individual owns the first business.

28. The method of claim 26, further comprising:
determining that the first individual is associated with a second business;
accessing a business credit information of the second business; and
including the business credit information of the second business in the generated combined presentation.

29. The method of claim 26, further comprising:
determining that a second individual is associated with the first business;
accessing a personal credit information of the second individual; and
including the personal credit information of the second individual in the generated combined presentation.

30. The method of claim 29, wherein determining that a second individual is associated with the first business comprises determining that the second individual is an owner of the first business.

31. The method of claim 26, further comprising:
monitoring the personal credit information of the first individual and the business credit information of the first business;
determining that activity related to either the personal credit information or the business credit information has occurred; and
sending an alert to the client computing device or another client computing device associated with the client computing device, the alert identifying that the activity has occurred.

32. The method of claim 31, wherein the activity comprises a change in the personal credit information of the business credit information.

33. The method of claim 31, wherein the activity comprises a change in the ownership of the first business.
